(19) United States
(12) Patent Application Publication
(10) Pub. No.: US 2024/0241324 A1
(43) Pub. Date: Jul. 18, 2024

(54) CYLINDRICAL MULTICORE FERRULE AND ITS POLISHING METHOD

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, 1-14-1 Tamagawa, setagaya-ku (JP)

(73) Assignee: NIPPON TELEGRAPH AND TELEPHONE CORPORATION, Tokyo (JP)

(21) Appl. No.: 18/562,732

(22) PCT Filed: Jun. 10, 2021
(86) PCT No.: PCT/JP2021/022146

§ 371 Date: Nov. 20, 2023

(51) Int. Cl. G02B 6/38; G02B 6/40

(52) U.S. Cl. CPC G02B 6/3834; G02B 6/3863; G02B 6/3878; G02B 6/403

(57) ABSTRACT

An object of the present disclosure is to enable a plurality of single fibers to be easily and collectively connected.

The present disclosure is a cylindrical multi-fiber ferrule including through holes each having a cylindrical shape and configured to hold a plurality of optical fibers on the same circle centered on a central axis of the cylindrical shape, in which a region where the through holes are arranged at one end of the cylindrical shape in a longitudinal direction has a spherical shape, and a central region where the through holes are not arranged at one end of the cylindrical shape in the longitudinal direction is a flat surface shape perpendicular to the longitudinal direction of the cylindrical shape.

### TECHNICAL FIELD

The present disclosure relates to a cylindrical multi-fiber ferrule used for collectively connecting a plurality of ports using optical fibers in an optical fiber network and a polishing method of the cylindrical multi-fiber ferrule.

### BACKGROUND ART

As a technology of connecting a plurality of single-mode optical fibers, there is a multi-fiber optical connector (for example, Non Patent Literature 1). In a general multi-fiber optical connector, two guide holes are provided in a ferrule having a rectangular end face, and a guide pin is inserted into the guide hole to perform connection.

Furthermore, there has also been developed an optical connector (for example, Non Patent Literature 2) in which reflection characteristics are improved by obliquely polishing the end face of the ferrule, and convenience is improved by providing a housing and attaching and detaching the housing by a push-pull mechanism.

On the other hand, as a technology of collectively connecting a plurality of ports of an optical fiber in an optical connector using a cylindrical ferrule, an optical connector using a multicore fiber (for example, Non Patent Literature 3) has been studied. In addition, an SC type (for example, Non Patent Literature 4) optical connector with improved axial rotation accuracy has also been studied.

However, in the conventional technology disclosed in Non Patent Literature 1 described above, in order to avoid deterioration of reflection characteristics due to difficulty in physical contact on the entire core wire, it is necessary to apply a refractive index matching material and use a dedicated tool for attachment and detachment, and there is a problem that the operation process is complicated.

In the conventional technology disclosed in Non Patent Literature 2, it is difficult to control a clearance between the guide hole and the guide pin, and there is a problem that the manufacturing of a low-loss optical connector increases the cost.

In the conventional technology disclosed in Non Patent Literature 3 and Non Patent Literature 4, it is necessary to use a multicore fiber to collectively connect a plurality of ports using a cylindrical ferrule, but the multicore fiber is expensive, and there is a problem that a wiring form becomes complicated because it is necessary to use a device such as a fan-in/fan-out.

### CITATION LIST

### Non Patent Literature

Non Patent Literature 1: M. Kawase, T. Fuchigami, M. Matsumoto, S. Nagasawa, S. Tomita, and S. Takashima, “Subscriber Single-Mode Optical Fiber Ribbon Cable Technologies Suitable for Mdspan Access,” J. Lightwave Technol., vol. 7, no. 11, pp. 1675-1681, 1989.
Non Patent Literature 2: M. Kihara, S. Nagasawa, and T. Tanifuji, “Design and Performance of an Angled Physical Contact Type Multifiber Connector,” J. Lightwave Technol., vol. 14, no. 4, pp. 542-548, 1996.
Non Patent Literature 3: Katsuyoshi Sakaime, Ryo Nagase, Kengo Watanabe, and Tsunetoshi Saito, “Mechanical characteristic of MU-Type MCF connector”, IEICE Technical Report, OCS2013-118, pp. 97-100, 2014.
Non Patent Literature 4: Tetsuya Kobayashi, Haruyuki Endo, Yosuke Minagawa, “Study on multicore fiber connectors”, IEICE Technical Report, OCS2014-33, pp. 13-16, 2014.

### SUMMARY OF INVENTION

### Technical Problem

An object of the present disclosure is to enable a plurality of single fibers to be easily and collectively connected.

### Solution to Problem

A cylindrical multi-fiber ferrule of the present disclosure includes
through holes each having a cylindrical shape and configured to hold a plurality of optical fibers on the same circle centered on a central axis of the cylindrical shape,
in which a region where the through holes are arranged at one end of the cylindrical shape in a longitudinal direction has a spherical shape curved with a predetermined curvature radius, and
a central region where the through holes are not arranged at one end of the cylindrical shape in the longitudinal direction is a flat surface perpendicular to the longitudinal direction of the cylindrical shape.

A polishing method of a cylindrical multi-fiber ferrule according to the present disclosure is a method of polishing a ferrule end face of the cylindrical multi-fiber ferrule according to the present disclosure, in which polishing is performed with a predetermined curvature radius, and then flat polishing is performed. Specifically, a polishing method of a cylindrical multi-fiber ferrule of the present disclosure includes fixing an optical fiber to at least any of through holes of a ferrule formed with the through holes each having a cylindrical shape and configured to hold a plurality of optical fibers on the same circle centered on a central axis of the cylindrical shape, polishing an end face of one end of the ferrule into a spherical shape curved with a predetermined curvature radius, and then, polishing a central region where the through holes are not arranged at the one end perpendicularly to a longitudinal direction of the cylindrical shape to form a flat surface.

### Advantageous Effects of Invention

According to the present disclosure, it is possible to easily and collectively connect a plurality of single fibers, and thus, it is possible to achieve economical optical connection.

### BRIEF DESCRIPTION OF DRAWINGS

FIG. 1 is a schematic diagram illustrating a ferrule cross section according to an embodiment of the present disclosure.

FIG. 2 is a schematic diagram illustrating a side surface of a coupling portion according to the embodiment of the present disclosure.

FIG. 3 is a schematic diagram illustrating a vicinity of a ferrule end face of the optical coupling portion according to the embodiment of the present disclosure.

FIG. 4 is a diagram illustrating a flowchart of a ferrule end face polishing method according to an embodiment of the present disclosure.

FIG. 5 is a diagram illustrating an example of a relationship between an angle of a fiber end face with respect to a ferrule flat surface and a reflection attenuation amount.

FIG. 6 is a diagram illustrating an example of a relationship of excess loss with respect to a gap of an optical fiber.

FIG. 7 is a diagram illustrating an example of a relationship between an angle of a fiber end face with respect to a ferrule flat surface and a curvature radius.

FIG. 8 is a diagram illustrating an example of a relationship between an angle of a fiber end face with respect to a ferrule flat surface and an amount of recess from the vertex.

FIG. 9 is a diagram illustrating an example of a relationship of the number of cores of an optical fiber with respect to a core arrangement radius.

FIG. 10 is a diagram illustrating an example of a relationship between a rotational angle deviation and an excess loss due to the rotational angle deviation.

FIG. 11 is a schematic diagram illustrating a fitting form of an optical coupling portion in an optical connector according to a first embodiment of the present disclosure.

FIG. 12 is a diagram illustrating an example of a configuration in which a capillary is attached inside a flange.

FIG. 13 is a diagram illustrating an example of a configuration in which a flange is attached to a ferrule.

FIG. 14 is a diagram illustrating an example of a mechanism capable of rotating and fixing a ferrule inside a plug frame according to the first embodiment of the present disclosure.

FIG. 15 is a schematic diagram illustrating the mechanism capable of rotating and fixing a ferrule inside a plug frame according to the first embodiment of the present disclosure.

FIG. 16 is a schematic diagram illustrating a mechanism capable of rotating and fixing a ferrule inside a plug frame according to a second embodiment of the present disclosure.

### DESCRIPTION OF EMBODIMENTS

Hereinafter, embodiments of the present disclosure will be described in detail with reference to the drawings. Note that the present disclosure is not limited to the embodiments described below. These examples are merely examples, and the present disclosure can be carried out in a form with various modifications and improvements based on the knowledge of those skilled in the art. Note that components having the same reference numerals in the present specification and the drawings denote the same components.

Hereinafter, embodiments of the present disclosure will be described in detail with reference to the drawings.

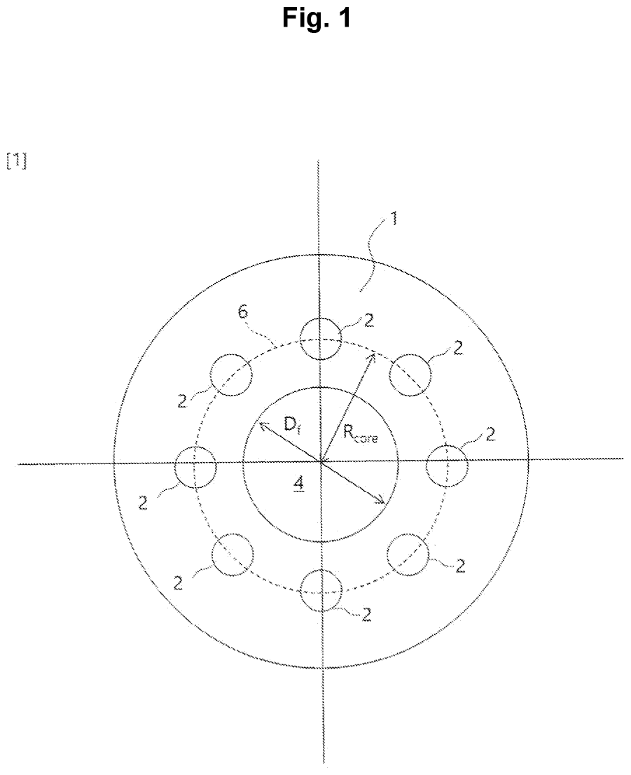

FIG. 1 is a schematic diagram illustrating a cross-sectional structure of a cylindrical multi-fiber ferrule according to an embodiment of the present disclosure. A ferrule 1 is the cylindrical multi-fiber ferrule of the present disclosure, has a cylindrical shape, and has a through hole for holding a plurality of optical fibers 2 in parallel with the longitudinal direction of the cylindrical shape. One optical fiber 2 is arranged in each through hole. FIG. 1 illustrates a state in which the optical fiber 2 is held in each through hole. The core centers of the plurality of optical fibers 2 are arranged on the same circle having a core arrangement radius R_{core} with respect to the central axis of the cylindrical shape of the ferrule 1.

Although FIG. 1 illustrates an example in which eight through holes are arranged at equal intervals and the optical fibers 2 are arranged in all the through holes, it is sufficient that the core centers of the plurality of optical fibers 2 are arranged on the circumference of a circle having the core arrangement radius R_{core}, and the present invention is not limited thereto. For example, it is sufficient that the optical fiber 2 is arranged in at least one of the eight through holes. In the present embodiment, an example in which the plurality of optical fibers 2 are arranged on one circumference is described, but the plurality of optical fibers 2 may be arranged in two or more circles. The optical fiber 2 is generally formed of quartz glass, but is not limited thereto as long as it is an optical fiber capable of communicating signal light in a communication wavelength band. The ferrule 1 is generally formed of zirconia, but is not limited thereto as long as it can hold the optical fiber 2. At one end of the ferrule 1 in the longitudinal direction, the plurality of optical fibers 2 are arranged in a spherical region 6 arranged outside a ferrule flat surface 4. The spherical region 6 is a curved region curved with a predetermined curvature radius. The ferrule flat surface 4 is arranged on the central axis of the ferrule 1 and is a surface with which the two ferrules are brought into contact.

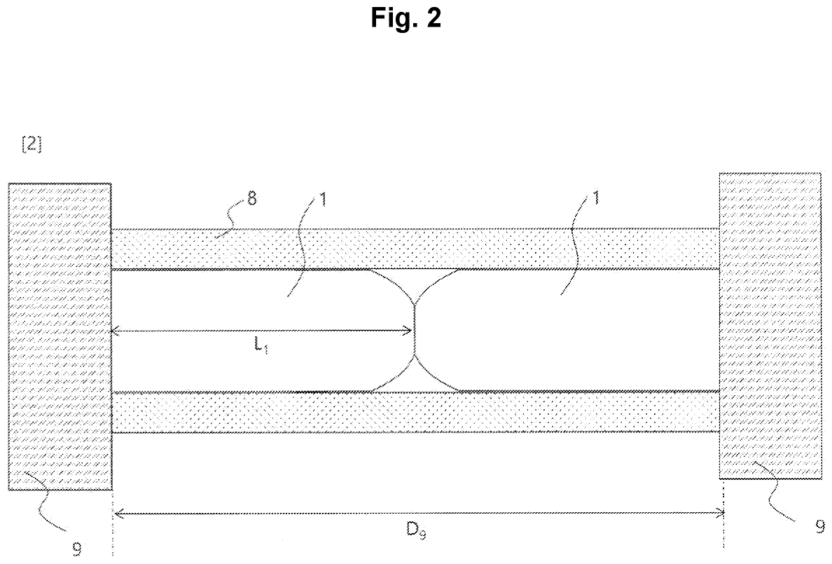

FIG. 2 is a schematic diagram illustrating a side surface of an optical coupling portion of the cylindrical multi-fiber ferrule according to the embodiment of the present disclosure. The two ferrules 1 into which the optical fibers are inserted are aligned by a sleeve 8. As a result, the axial deviation of the two ferrules 1 is controlled within a certain allowable range. In order to minimize the connection loss in the optical coupling portion of the two ferrules 1, it is desirable that the cores of the plurality of optical fibers inserted into the two ferrules 1 have the same optical characteristics in terms of having similar mode field diameters. It is important to minimize the connection loss due to the axial deviation and the rotational deviation of the optical fibers inserted into the two ferrules 1, and it is desirable that the optical fibers inserted into the two ferrules 1 be arranged at opposing positions on the circumference having the same core arrangement radius on the ferrule end faces of the ferrules 1. In order to minimize the connection loss due to axial deviation, it is desirable that the ferrule outer diameters of the two ferrules 1 are substantially the same. In order to reduce the gap between the end faces of the optical fibers inserted into the two ferrules 1 as much as possible to reduce the excess loss due to the gap, it is important that the ferrule flat surfaces of the two ferrules 1 can be brought into contact with each other, and a distance D₉ between flanges 9 of the two ferrules 1 in the ferrule axial direction is desirably about the same as or shorter than the sum of a lengths Li of the two ferrules 1 in the ferrule axial direction.

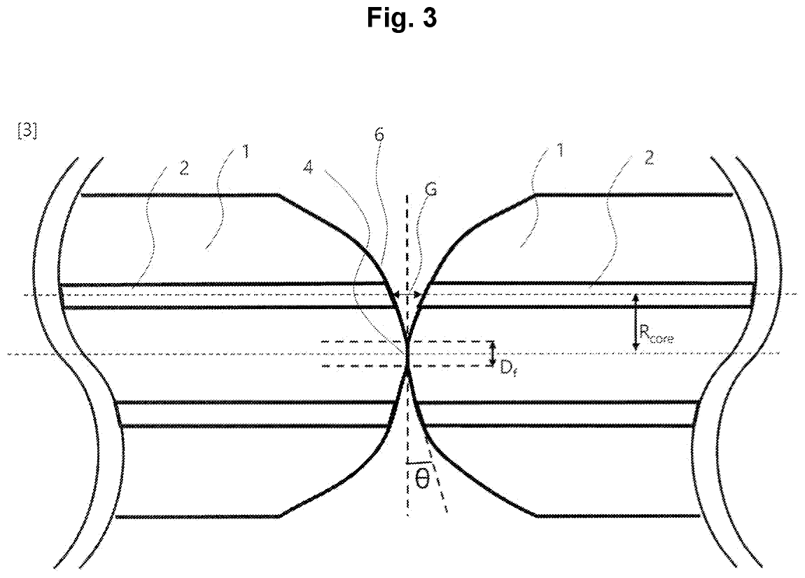

FIG. 3 is a schematic diagram illustrating a vicinity of the ferrule end face of the optical coupling portion in more detail. The two ferrules 1 are in contact with each other at the ferrule flat surface 4 at the central portion of each end face. The ferrule flat surface 4 is a central region surrounded by the spherical region 6 where no through hole is arranged, and is perpendicular to the longitudinal direction of the cylindrical shape. Each of the plurality of optical fibers 2 is arranged in the spherical region 6 of the ferrule 1 in order to prevent the end face of each of the optical fibers 2 from being damaged by contact. In the end face of the optical fiber 2, an angle θ of the end face of the optical fiber 2 with respect to the ferrule flat surface 4 is controlled in order to suppress signal characteristic deterioration due to reflection. Here, in the present disclosure, the end faces of the optical fibers 2 each have a spherical shape. The angle θ may be an angle of a tangent line at a core position among positions where the optical fibers 2 are arranged with respect to the ferrule flat surface 4.

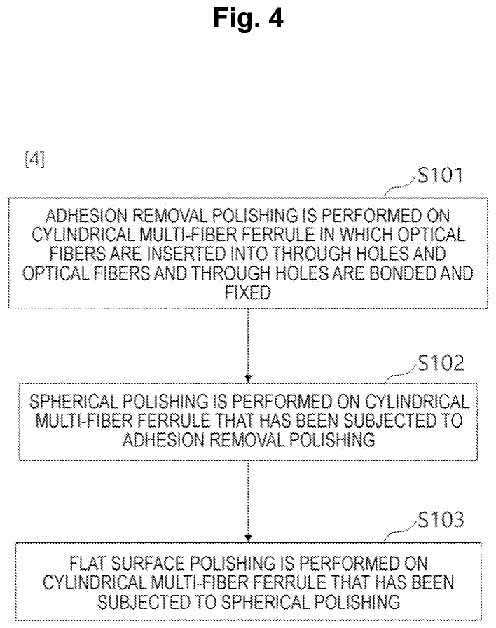

FIG. 4 is a diagram illustrating a flowchart illustrating an example of a polishing method of a cylindrical multi-fiber ferrule according to an embodiment of the present disclosure. In the polishing method of a cylindrical multi-fiber ferrule according to the present embodiment, steps S101 to S103 are sequentially performed.

Step S101: First, the optical fibers 2 are inserted into the through holes, and the optical fibers 2 and the through holes are bonded and fixed, and adhesion removal polishing of the ferrule 1 is performed. In general, in the ferrule 1 in which the optical fiber 2 is inserted and bonded and fixed, since an excessive adhesive adheres to the ferrule end face, polishing is performed to remove the excessive adhesive.

Step S102: Next, spherical polishing is performed on the ferrule 1 that has been subjected to the adhesion removal polishing. By polishing the entire end face of the ferrule 1 including the ferrule flat surface 4 and the spherical region 6 into a spherical shape having a predetermined curvature radius ROC, it is possible to form a spherical shape of the spherical region 6 in which the plurality of optical fibers 2 of the ferrule 1 are arranged.

Step S103: Subsequently, spherical polishing is performed on the ferrule flat surface 4 that has been subjected to the spherical polishing. In general, in polishing the ferrule 1, a polishing sheet on which a polishing agent is sprayed is placed on a pad, and polishing is performed while an end face of the ferrule 1 is pressed against a surface of the polishing sheet. Here, it is possible to polish only the central portion of the ferrule 1 into a flat shape to form the ferrule flat surface 4 by performing polishing by adjusting the polishing time using a pad having a hard hardness.

The spherical shape is any shape in which the curvature radius ROC of the spherical region has a predetermined value. The spherical region is symmetrical with respect to the center of the spherical surface, and the center of the spherical surface may be arranged on the central axis of the cylindrical shape of the ferrule 1 or may be arranged at other positions.

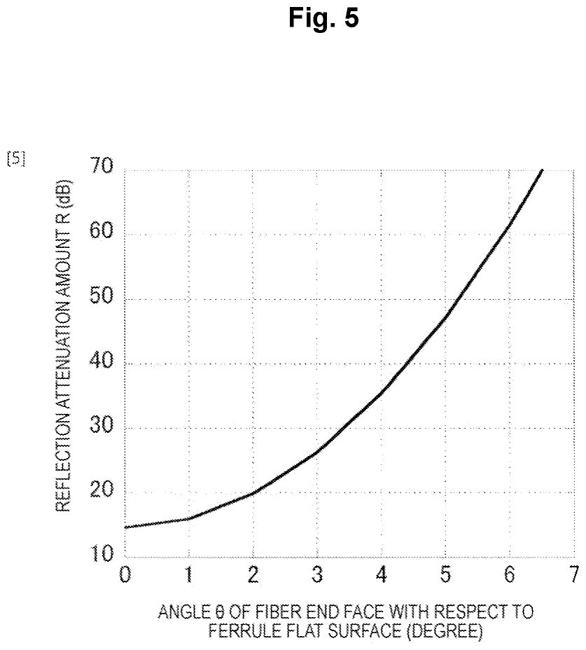

FIG. 5 is a diagram illustrating an example of a relationship between an angle θ of an end face of the optical fiber 2 with respect to the ferrule flat surface 4 and a reflection attenuation amount R. In optical coupling between the optical fibers 2, when there are regions having different refractive indexes between the end faces of the optical fibers 2, signal characteristics are deteriorated due to reflection at boundaries having different refractive indexes. In the present disclosure, there is a gap between the end faces of the optical fibers 2 inserted into the two ferrules 1. When this gap is air, quartz glass and air have different refractive indexes, and thus it is necessary to devise a technique for reducing reflection. In the present disclosure, reflection is reduced by controlling the angle θ.

The relationship between the angle θ (unit: degree) of the end face of the optical fiber 2 with respect to the ferrule flat surface 4 and the reflection attenuation amount R (unit: dB) can be expressed by the following expression.

$$[ Math . 1 ]$$

$$R = 10 \frac{{( π \times {n}_{1} \times {ω}_{1} )}^{2}}{{λ}^{2}} \times log ( e ) \times {( 2 θ )}^{2} + {R}_{0} \qquad ( 1 )$$

Here, n₁, ω₁, and λ are the refractive index of the core of the optical fiber 2, the mode field radius of the core of the optical fiber 2, and the signal wavelength, respectively.

Ro is a reflection attenuation amount in the case of θ=0 degrees, and can be expressed by the following expression.

$$[ Math . 2 ]$$

$${R}_{0} = - 10 \cdot log [ {( \frac{{n}_{1} - {n}_{2}}{{n}_{1} + {n}_{2}} )}^{2} ] \qquad ( 2 )$$

Here, n₂ is a refractive index of a light receiving medium.

In the present embodiment, since light emitted from the end face of the optical fiber 2 propagates air, n₂ is a refractive index of air. When the wavelength λ is 1310 nm and the mode field radius ω₁ is 4.5 μm, the reflection attenuation amount Ro at 0=0 is 14.7 dB, and by setting the angle θ of the end face of the optical fiber 2 with respect to the ferrule flat surface 4 to five degrees or more, the reflection attenuation amount R of 40 dB or more can be maintained.

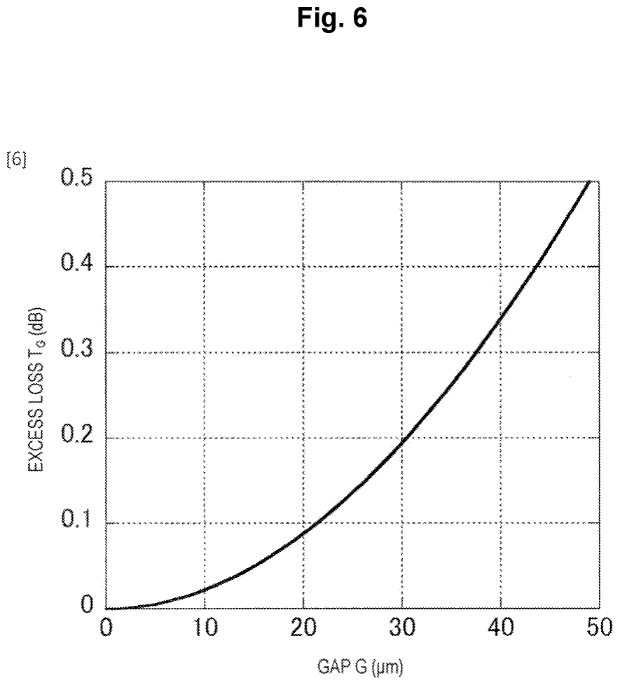

FIG. 6 is a diagram illustrating an example of a relationship of excess loss T_{G} with respect to a gap G of the optical fiber 2. In the optical coupling between the optical fibers 2, if the gap exists between the end faces of the optical fibers 2, a distribution of the emitted light of the input-side optical fiber is widened, and coupling efficiency with the core of the output-side optical fiber is reduced, which causes excess loss. The relationship between the gap G (unit: μm) and the excess loss T_{G} (unit: dB) can be expressed by the following expression.

$$[ Math . 3 ]$$

$${T}_{G} = \frac{4 [ 4 {G}^{2} + \frac{{w}_{1}^{2}}{{w}_{2}^{2}} ]}{[ 4 {G}^{2} + \frac{{w}_{2}^{2} + {w}_{1}^{2}}{{w}_{2}^{2}} ] + 4 {G}^{2} \frac{{w}_{2}^{2}}{{w}_{1}^{2}}} \qquad ( 3 )$$

Here, W₁ and W₂ are mode field radii of cores of the optical fibers 2 on the input side and the output side, respectively. FIG. 6 is a diagram illustrating a loss when the mode field radii of the cores of the optical fibers inserted into the two ferrules 1 are both 4.5 μm. For example, by adjusting the gap between the end faces of the optical fibers 2 inserted into the two ferrules 1 to equal to or less than 20 μm, the excess loss can be suppressed to equal to or less than 0.1 dB.

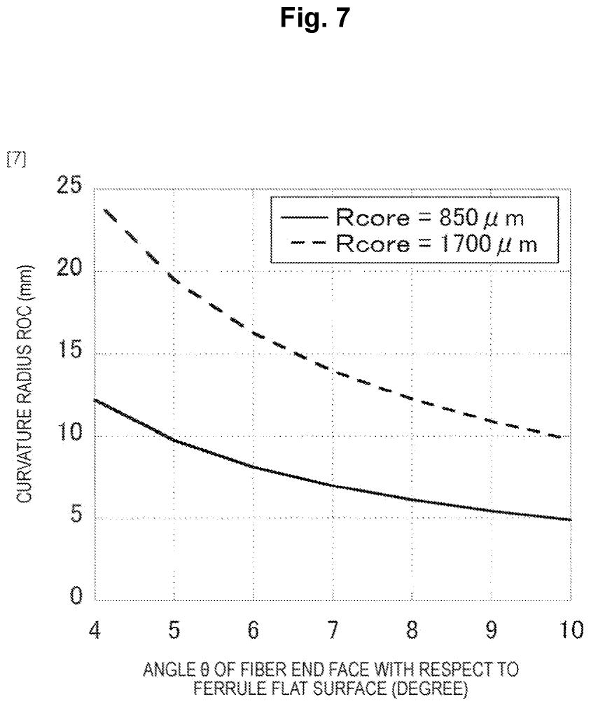

FIG. 7 is a diagram illustrating an example of a relationship between an angle θ of an end face of the optical fiber 2 with respect to the ferrule flat surface 4 and the curvature radius ROC. When the optical connector is manufactured, the end face of the ferrule 1 is polished in order to control the reflection attenuation amount of the optical connector. According to the polishing conditions, the end face shape of the ferrule 1 to which the optical fiber 2 is inserted is controlled, and a desired reflection attenuation amount can be obtained.

In general, in polishing the ferrule 1, a polishing sheet on which a polishing agent is sprayed is placed on a pad, and polishing is performed while an end face of the ferrule is pressed against a surface of the polishing sheet. It is possible to adjust the curvature radius of the end face of the ferrule by performing polishing using the hardness of the pad, the pressing force of the ferrule 1, the polishing time, and the like as parameters. The relationship between the angle θ (unit: degree) of the end face of the optical fiber 2 with respect to the ferrule flat surface 4 and the curvature radius ROC (unit: mm) can be expressed by the following expression.

$$[ Math . 4 ]$$

$$ROC = \frac{{R}_{core}}{sin θ} \qquad ( 4 )$$

In the example illustrated in FIG. 7, the core arrangement radius R_{core} is 850 μm and 1700 μm. For example, when the core arrangement radius R_{core} is 850 μm, the angle θ of the end face of the optical fiber 2 can be set to equal to or greater than five degrees by setting the curvature radius ROC to equal to or less than 9.7 mm, and the reflection attenuation amount R of equal to or greater than 40 dB can be achieved. In addition, in order to enable more optical fibers 2 to be arranged, when the core arrangement radius R_{core} is increased to 1700 μm, the angle θ of the end face of the optical fiber 2 can be set to equal to or greater than five degrees by setting the curvature radius ROC to equal to or less than 19.5 mm, and the reflection attenuation amount R of equal to or greater than 40 dB can be achieved.

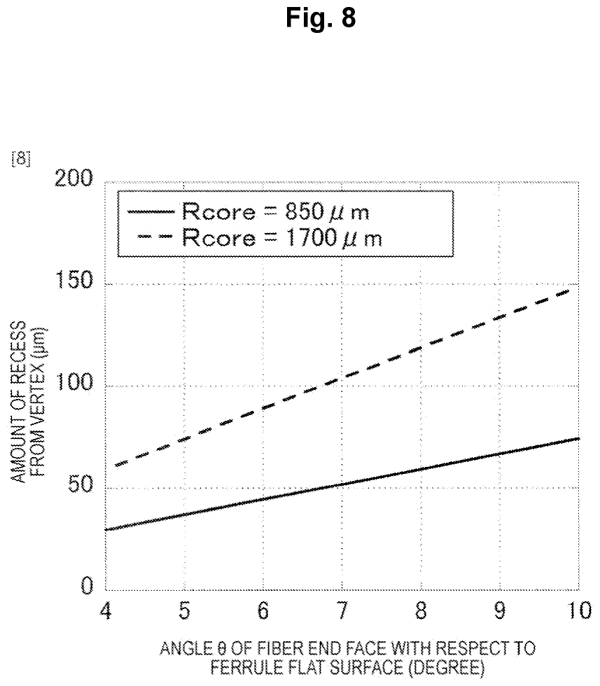

FIG. 8 is a diagram illustrating an example of a relationship between an angle θ of the end face of the optical fiber 2 with respect to the ferrule flat surface 4 and an amount of recess from the vertex. Here, the amount of recess from the vertex represents a difference in the retraction position of the end face of the optical fiber 2 at the core arrangement radius R_{core} from the position of the vertex of the spherical surface of the ferrule end face polished with the curvature radius illustrated in FIG. 7 in the axial direction of the ferrule 1. In the example illustrated in FIG. 8, the core arrangement radius R_{core} is 850 μm and 1700 μm. For example, when the angle θ of the end face of the optical fiber 2 is five degrees, the amount of recess is 37 μm to 74 μm when the core arrangement radius R_{core} is 850 μm to 1700 μm. For this reason, when the ferrules polished with the curvature radius described above are connected to each other, a large gap is generated between the optical fibers 2.

From FIG. 6, it is necessary to set the gap to equal to or less than 20 μm in order to suppress the excess loss due to the gap. For this reason, after polishing is performed so as to have the curvature radius ROC illustrated in FIG. 7, polishing is performed using a pad having a harder hardness, and the distance from the ferrule flat surface 4 to the end face of the optical fiber 2 is set to 10 μm or less. As a result, it is possible to flatly polish only the central portion of the end face of the ferrule polished with the curvature radius ROC to reduce the difference between the position of the ferrule flat surface 4 at the center of the ferrule end face and the retraction position of the end face of the optical fiber 2 at the core arrangement radius R_{core} in the axial direction of the ferrule.

For example, in the ferrule end face polished so that the core arrangement radius R_{core} is 850 μm, the angle θ of the end face of the optical fiber 2 is five degrees, and the curvature radius is 9.7 mm, by performing flat polishing to a depth of 27 μm from the vertex of the ferrule end face, a reflection attenuation amount of equal to or greater than 40 dB and an excess loss due to a gap of equal to or less than 0.1 dB can be achieved. In addition, for example, in the ferrule end face polished so that the core arrangement radius R_{core} is 1700 μm, the angle θ of the end face of the optical fiber 2 is five degrees, and the curvature radius is 19.5 mm, by performing flat polishing to a depth of 64 μm from the vertex of the ferrule end face, a reflection attenuation amount of equal to or greater than 40 dB and an excess loss due to a gap of equal to or less than 0.1 dB can be achieved.

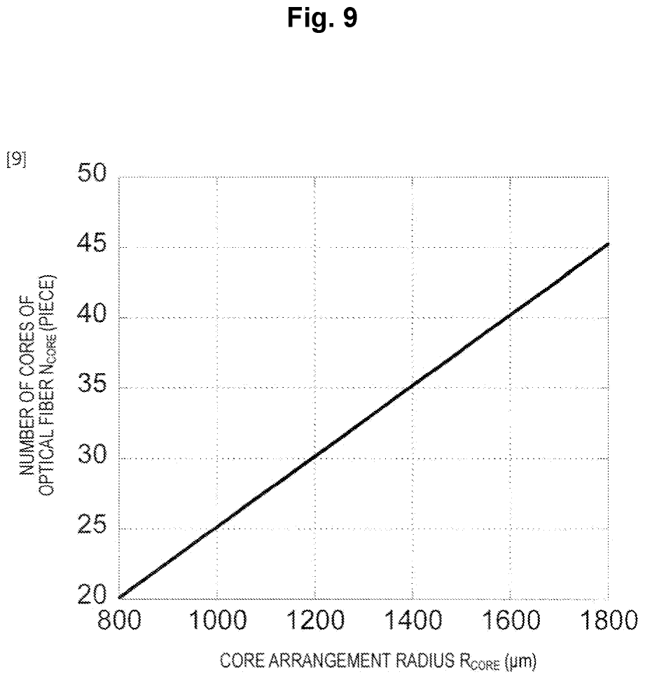

FIG. 9 is a diagram illustrating an example of a relationship of the number of cores N_{core} of the optical fiber 2 with respect to the core arrangement radius R_{core}. FIG. 9 is an example illustrating the number of cores of the optical fiber 2 when the optical fibers 2 are arranged at equal intervals in an annular shape on the core arrangement radius and the distance between cores of the adjacent optical fibers 2 is 250 μm. For example, by arranging the optical fibers 2 at equal intervals such that the core arrangement radius R_{core} is 850 μm and the distance between adjacent cores is 250 μm, 21 optical fibers 2 can be collectively connected. In addition, by setting the core arrangement radius R_{core} to 1700 μm, 42 optical fibers 2 can be collectively connected.

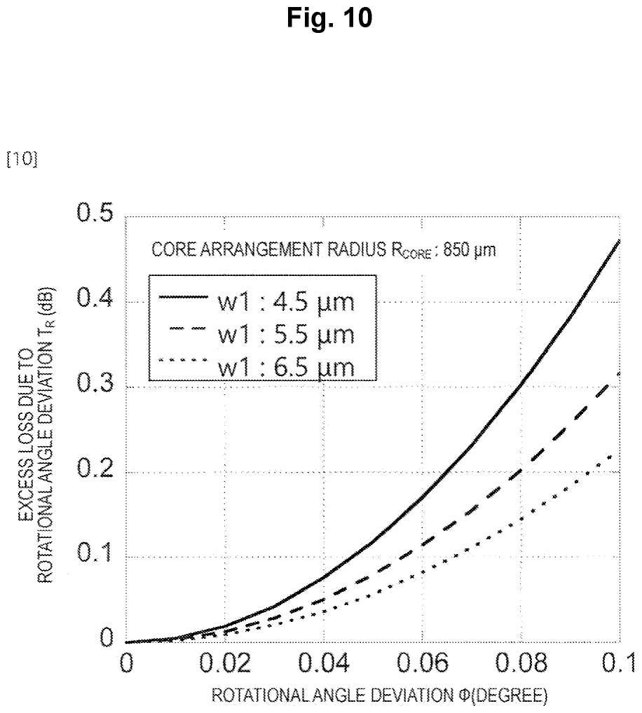

FIG. 10 is a diagram illustrating an example of a relationship between a rotational angle deviation and an excess loss T_{R} due to a rotational angle deviation @. In the configuration of the optical coupling portion of the cylindrical multi-fiber ferrule of the present disclosure, the rotational angle deviation at the time of manufacturing the optical connector causes excess loss. When the excess loss due to the rotational angle deviation is denoted by T_{R} (unit: dB), the rotational angle deviation is denoted by @ (unit: degree), and the core arrangement radius is denoted by R_{core} (unit: μm), the relationship among these can be expressed by the following expression.

$$[ Math . 5 ]$$

$${T}_{R} = {( \frac{2 {w}_{1} {w}_{2}}{{w}_{1}^{2} + {w}_{2}^{2}} )}^{2} exp [ 1 \frac{2 {( 2 {R}_{sore} sin 2 π \frac{Φ}{360} )}^{2}}{{w}_{1}^{2} + {w}_{2}^{2}} ] \qquad ( 5 )$$

Here, w₁ and w₂ are mode field radii of cores of the optical fibers 2, respectively.

In the example illustrated in FIG. 10, the core arrangement radius R_{core} is 850 μm. As the rotational angle deviation @ increases, the excess loss T_{R} increases, and the connection characteristics deteriorate. In the example illustrated in FIG. 10, the mode field radius w₁ is 4.5 μm, 5.5 μm, and 6.5 μm. As is clear from these comparisons, by using the optical fiber 2 having a larger mode field radius w₁, it is possible to reduce excess loss due to rotational angle deviation as compared with the optical fiber 2 having a smaller mode field radius.

According to the present disclosure, the ferrule end face of the cylindrical multi-fiber ferrule is polished with a desired curvature radius, and then the ferrule central portion is flatly polished, so that the central portion of the cylindrical multi-fiber ferrule has a flat shape, and the end faces of the optical fibers 2 arranged in an annular shape each have a spherical shape. Therefore, in optical connector connection using the cylindrical multi-fiber ferrule of the present disclosure, excellent optical characteristics are achieved with preferable reflection characteristics and reduced excess loss due to a gap. In addition, in the polishing method of a cylindrical multi-fiber ferrule of the present disclosure, the ferrule end face is polished so as to have a desired curvature radius, and then only the central portion of the ferrule is subjected to flat polishing. Therefore, a special polishing device or polishing jig is not required, and the ferrule can be polished by a simple and economical method.

### First Embodiment

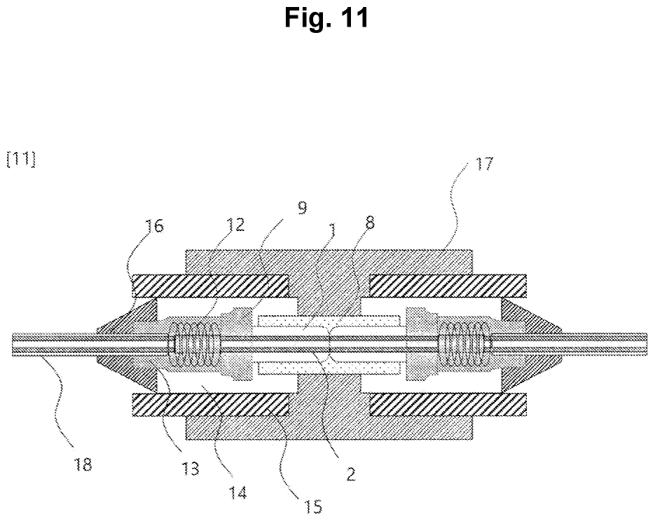

FIG. 11 is a schematic diagram illustrating a fitting form of an optical coupling portion in an optical connector according to a first embodiment of the present disclosure. Two ferrules 1 are inserted into the sleeve 8 so as to face each other, and ferrule flat surfaces of the two ferrules 1 are brought into contact with each other by applying pressure by a spring 12, and thereby, optical fibers 2 are connected in a state where a gap is provided between end faces of the optical fibers 2. In order to facilitate attachment and detachment in connection, the sleeve 8 is incorporated in an adapter 17, and each of the two ferrules 1 is incorporated in a plug frame 14 attached to a housing 15.

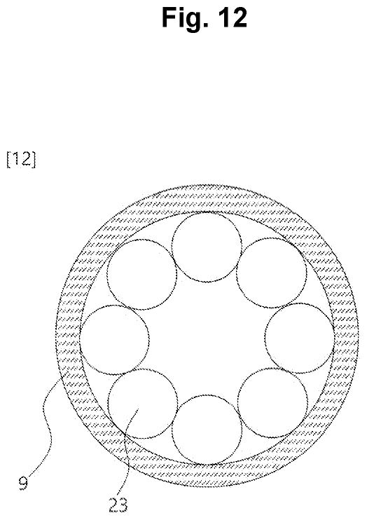

Each of the two ferrules 1 is attached with a flange 9 for protecting the optical fibers 2. As illustrated in FIG. 12, the optical fibers 2 can be easily inserted into the ferrules by inserting a plurality of capillaries 23 into the flanges 9 and arranging the capillaries 23 at the same positions as through holes 24 for holding the optical fibers 2.

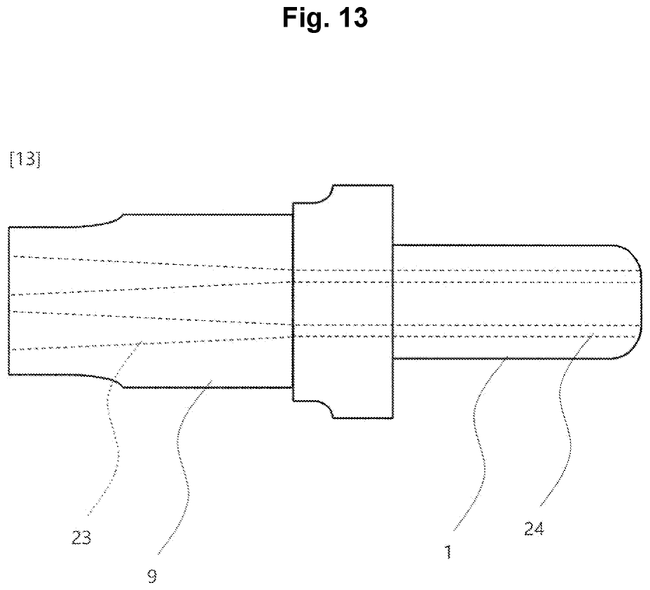

As illustrated in FIG. 13, by tapering the capillaries 23 in the longitudinal direction and making the diameter of the tip of the tapered shape close to the diameter of the through holes 24 for holding the optical fibers 2, it is possible to prevent the optical fiber 2 from being caught due to a step when the optical fiber 2 is inserted into the ferrule 1 and to prevent the optical fiber 2 from being broken.

Although the example in which the plurality of capillaries 23 are inserted into the flanges 9 has been described in the present embodiment, the present invention is not limited thereto as long as the optical fibers 2 have a shape that allows the optical fibers 2 to be inserted into the through holes 24 of the ferrules 1 and that can protect the optical fibers 2 at the time of manufacturing the optical connector.

The flange 9 attached to one of the two ferrules 1 is provided with a cutout (not illustrated), and axial rotation of the cutout of the flange 9 is fixed by a guide of a cutout provided in the plug frame 14. The other ferrule 1 is attached with a mechanism (not illustrated) that enables rotation and fixation inside the plug frame 14.

When an optical connector is manufactured, that is, when the optical fibers 2 are connected, a housing (connector plug) incorporating a ferrule attached with a flange with a cutout is inserted into one side of an adapter, a housing (connector plug) attached with a ferrule capable of rotating and fixing inside a plug frame is inserted into the other side of the adapter, a device (for example, a light source and a light receiver) capable of transmitting and receiving is attached to each of the optical fibers 2, the ferrule is rotated while monitoring an optical signal, and axial rotation of the ferrule is fixed at a position where received light power is maximized, and thereby a low-loss optical connector can be manufactured.

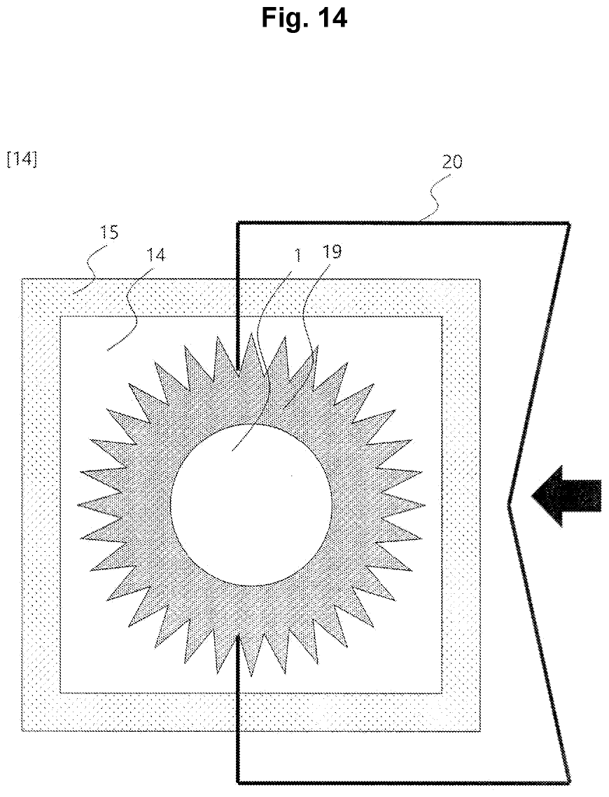

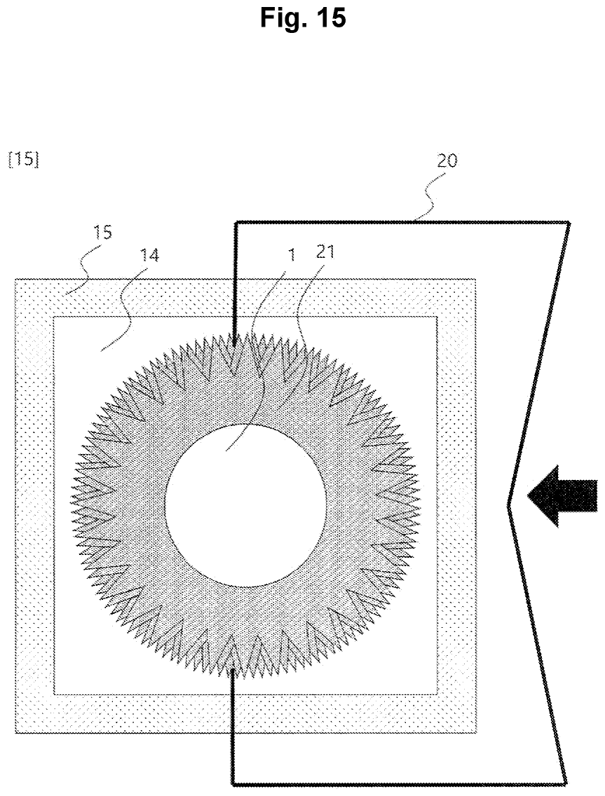

FIG. 14 is a diagram illustrating an example of a mechanism that enables the cylindrical multi-fiber ferrule to be rotated and fixed inside the plug frame according to the first embodiment of the present disclosure. FIG. 14 is a cross-sectional view of a connector plug attached with the mechanism that enables the ferrule 1 to be rotated and fixed inside the plug frame 14. A grooved flange 19 is attached to the ferrule 1, and a fixing spring 20 is attached in a shape in which a tip thereof is sandwiched between the grooves. By pressing the fixing spring 20 in the direction of the arrow in the drawing, the tip of the fixing spring 20 is detached from the groove of the grooved flange 19, which enables the grooved flange 19 to axially rotate. By releasing the pressing force of the fixing spring 20 at a position where the monitored received light power is maximized, the grooved flange 19 is fixed, that is, the ferrule 1 is fixed, and the axial rotation direction of the inserted optical fiber 2 is fixed. For example, as illustrated in FIG. 15, by attaching a plurality of annular portions 21 provided with grooves to the flange in an overlapping manner, it is possible to perform finer rotation angle control.

### Second Embodiment

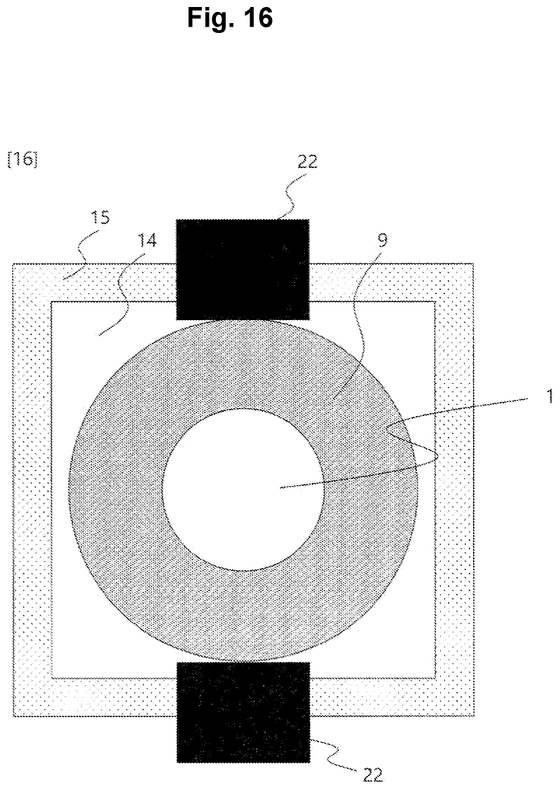

FIG. 16 is a diagram illustrating an example of a mechanism that enables a cylindrical multi-fiber ferrule to be rotated and fixed inside a plug frame according to a second embodiment of the present disclosure. FIG. 16 is a cross-sectional view of a connector plug attached with the mechanism that enables the ferrule to be rotated and fixed inside the plug frame. A flange 9 is attached to the ferrule 1, and a fixing magnet 22 is attached to the outside of the flange 9. By detaching the fixing magnet 22, the flange 9 is enabled to axially rotate and by attaching the fixing magnet 22 at a position where the monitored received light power is maximized, the flange 9 is fixed, that is, the ferrule is fixed, and the axial rotation direction of the inserted optical fiber 2 is fixed. Here, the flange 9 may be made of a material having magnetism.

### Effects of Present Disclosure

The cylindrical multi-fiber ferrule according to the present disclosure uses a single-mode fiber that is a single fiber generally used similarly to a normal optical connector as a connection technology for collectively connecting a plurality of ports by the optical fibers 2. Therefore, a device such as a fan in/fan out is not required as a transmission path configuration, and simple and economical optical connection can be achieved. In addition, since the central portion of the cylindrical multi-fiber ferrule has a flat shape and the end faces of the optical fibers 2 arranged in an annular shape each have a spherical shape, the excellent optical characteristics are achieved with preferable reflection characteristics and reduced excess loss due to a gap. Moreover, in the polishing method of a cylindrical multi-fiber ferrule of the present disclosure, the ferrule end face is polished so as to have a desired curvature radius, and then only the central portion of the ferrule is subjected to flat polishing. Therefore, a special polishing device or polishing jig is not required, and the ferrule can be polished by a simple and economical method.

### INDUSTRIAL APPLICABILITY

The present disclosure can be applied to information communication industry.

### REFERENCE SIGNS LIST

1 Ferrule
2 Optical fiber
4 Ferrule flat surface
6 Spherical region
8 Sleeve
9 Flange
12 Spring
13 Stop ring
14 Plug frame
15 Housing
16 Boot
17 Adapter
18 Cord coating
19 Grooved flange
20 Fixing spring
21 Annular portion provided with grooves
22 Fixing magnet
23 Capillary
24 Through hole

1. A cylindrical multi-fiber ferrule comprising
through holes each having a cylindrical shape and configured to hold a plurality of optical fibers on a same circle centered on a central axis of the cylindrical shape,
wherein a region where the through holes are arranged at one end of the cylindrical shape in a longitudinal direction has a spherical shape curved with a predetermined curvature radius, and
a central region where the through holes are not arranged at one end of the cylindrical shape in a longitudinal direction is a flat surface perpendicular to the longitudinal direction of the cylindrical shape.

2. The cylindrical multi-fiber ferrule according to claim 1,
wherein the curvature radius is equal to or less than 19.5 mm.

3. The cylindrical multi-fiber ferrule according to claim 1,
wherein an optical fiber is fixed to at least one of the through holes, and
an angle of a tangent at a core position of the optical fiber with respect to the flat surface is equal to or greater than five degrees.

4. The cylindrical multi-fiber ferrule according to claim 1,
wherein an amount of recess of the through holes from the flat surface at the one end of the cylindrical shape in the longitudinal direction is equal to or less than 10 μm.

5. A polishing method of a cylindrical multi-fiber ferrule, comprising:
fixing an optical fiber to at least any of through holes of a ferrule formed with the through holes each having a cylindrical shape and configured to hold a plurality of optical fibers on a same circle centered on a central axis of the cylindrical shape,
polishing an end face of one end of the ferrule into a spherical shape curved with a predetermined curvature radius, and
then, polishing a central region where the through holes are not arranged at the one end, perpendicularly to a longitudinal direction of the cylindrical shape to form a flat surface.

6. The polishing method of a cylindrical multi-fiber ferrule according to claim 5,
wherein the central region is polished such that a distance from the flat surface to the optical fibers fixed to the through holes is equal to or less than 10 μm when the polishing is performed perpendicularly.
